(19) United States
(12) Patent Application Publication
(10) Pub. No.: US 2020/0387340 A1
(43) Pub. Date: Dec. 10, 2020

(54) INTERACTIVE ELECTRONIC DEVICE REQUIRING MOVEMENT FOR INTERACTION

(71) Applicant: Ankush Raj Gaur, Oceanside, CA (US)

(72) Inventors: Ankush Raj Gaur, Oceanside, CA (US); Mansi Suman Gaur, Oceanside, CA (US); Kush Chris Gaur, Oceanside, CA (US); Michael Edward Yudelevich, Oceanside, CA (US); Ram Anand Dixit, Oceanside, CA (US); Andrew Petersen, Oceanside, CA (US); Naginder Kumar Gaur, Oceanside, CA (US)

(73) Assignee: Ankush Raj Gaur, Oceanside, CA (US)

(21) Appl. No.: 16/435,965

(22) Filed: Jun. 10, 2019

(51) Int. Cl. G06F 3/16; G06F 3/01; H04R 1/02; H04R 3/00

(52) U.S. Cl. CPC G06F 3/165; G06F 3/017; H04R 2420/07; H04R 3/00; H04R 1/025

(57) ABSTRACT

The present disclosure is directed to an interactive electronic device having functionality or output unlocked or made available based on movement of the interactive electronic device. The interactive electronic device may require a specified level of movement in order to allow playback of an audio file, and information relating to the status of the interactive electronic device may be transmitted to an associated electronic communication device to continue interaction and functionality.

### BACKGROUND

Electronic devices are often used to provide media to users. The media provided is often in the genre of educational or entertainment based. The media may be provided in a passive manner, such that users continuously receive the output and are mere observers. This passively received media is often not effectively processed or comprehended due to the lack of user involvement.

Some solutions for increasing processing and comprehension of output have been to have a two-way interaction, wherein a user receives the output and then interacts with the electronic device to reinforce processing and comprehension.

However, these solutions have failed to provide appropriate developmental related motivation and reinforcement for providing a user with output. For example, an individual may use an educational application on a tablet, and provide responses based on a touch interface. However, this interaction makes little use of other developmental factors, such as synchronizing verbalization with movement. In small children, this may be similar to learning to talk and walk. In adults suffering from neurological deficit as in stroke, this may be similar to re-learning how to walk and talk.

Additionally, current solutions fail to take advantage of the fact that when an individual is receiving a particularly enthralling output, such as an interesting story, the user may be willing to undertake certain specific actions to receive additional output. This motivation has yet to be harnessed.

Thus, what is needed is an electronic device configured to provide entertainment or educational output in a non-passive manner, such as by being prompted by continuous movement, taking advantage of developmental factors and motivation.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an interactive electronic device.

In one embodiment, the interactive electronic device may comprise: a device processor operable for controlling the interactive electronic device; a movement detection component operatively coupled to the device processor and controlled in part by the device processor, wherein the movement detection component generates a movement signal based on a movement of the interactive electronic device; an electronic storage component operatively coupled to the device processor and controlled in part by the device processor, wherein the electronic storage component stores at least one electronic file; and an audio output component operatively coupled to the device processor and controlled in part by the device processor, wherein the audio output component may be configured to output the electronic file as instructed by the device processor; wherein the device processor may be configured to cause the electronic file to be output by, at least, the audio output component based on the generated movement signal. The movement signal may comprise an average acceleration of the movement detection component. The device processor may be configured to cause the electronic file to be output by, at least, the audio output component when the average acceleration of the movement detection component exceeds a pre-determined value. The device processor may be configured to stop playback of the electronic file by the audio output component when the average acceleration may be below a pre-determined value. The device processor may be configured to start playback of the electronic file when the movement detection component indicates the interactive electronic device may be moving. The device processor may be configured to stop playback of the electronic file by the audio output component when the generated movement signal indicates that the movement detection component has stopped moving. The device processor may be configured to communicate with other nearby devices to provide a synchronized narrative wherein movement from multiple users prolongs audio output. The movement detection component may continuously transmit the generated movement signal to the device processor. The device processor may be configured to continue playback of the electronic file by the audio output component as long as the generated movement signal indicates that the movement detection component may be in movement. The interactive electronic device further may comprise: an input/output device operatively coupled to the device processor and configured to operatively connect the device processor to an associated electronic communication device, wherein the input/output device may be configured to send a plurality of electronic communications to the associated electronic communication device, wherein the plurality of sent electronic communications comprise data comprising movement data and electronic file output status. The associated electronic communication device may display to a user the data comprising movement data and the file output status. The file output status may comprise how much of the audio file has been output. The movement data may comprise movement of the interactive electronic device. The associated electronic communication device may provide interaction with the user depending on the file output status and the movement data. The electronic file may be an electronic audio file. The audio output may be a speaker. The audio output may be an audio jack. The audio output may be a wireless audio transmission component. The electronic storage component may be a removeable storage mechanism.

In another embodiment, the interactive electronic device may comprise a device processor operable for controlling the interactive electronic device; a movement detection component operatively coupled to the device processor and controlled in part by the device processor, wherein the movement detection component generates a movement signal based on a movement of the interactive electronic device; an electronic storage component operatively coupled to the device processor and controlled in part by the device processor, wherein the electronic storage component stores at least one electronic file; an audio output component operatively coupled to the device processor and controlled in part by the device processor, wherein the audio output component may be configured to output the electronic file as instructed by the device processor; and an input/output device operatively coupled to the device processor and configured to operatively connect the device processor to an associated electronic communication device, wherein the input/output device may be configured to send a plurality of electronic communications to the associated electronic communication device, wherein the plurality of sent electronic communications comprise data comprising movement data and electronic file output status; wherein the device processor may be configured to cause the electronic file to be output by, at least, the audio output component based on the generated movement signal; wherein the movement signal may comprise an average acceleration of the movement detection component; wherein the device processor may be configured to cause the electronic file to be output by, at least, the audio output component when the average acceleration of the movement detection component exceeds a pre-determined value; wherein the device processor may be configured to stop playback of the electronic file by the audio output component when the average acceleration may be below a pre-determined value; wherein the movement detection component continuously transmits the generated movement signal to the device processor; wherein the device processor may be configured to continue playback of the electronic file by the audio output component as long as the generated movement signal indicates that the movement detection component may be in movement; wherein the file output status may comprise how much of the audio file has been output; wherein the movement data may comprise movement of the interactive electronic device; wherein the associated electronic communication device provides interaction with the user depending on the file output status and the movement data; wherein the electronic file may be an electronic audio file; wherein the audio output may be a speaker; and wherein the electronic storage component may be a removeable storage mechanism.

In accordance with the embodiments disclosed herein, there may be provided a system for operating an interactive electronic device in conjunction with an electronic communication device.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 illustrates a block diagram of one embodiment of an interactive electronic device according to some embodiments.

FIG. 2 is a flow block diagram of one embodiment of a method of operating an interactive electronic device.

FIG. 3 is a flow block diagram of one embodiment of a method of operating an interactive electronic device and communicating with an associated electronic communication device.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems.

These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In various implementations, the interactive electronic device may be configured to send and receive messages to other interactive electronic devices, electronic communication devices, and the like.

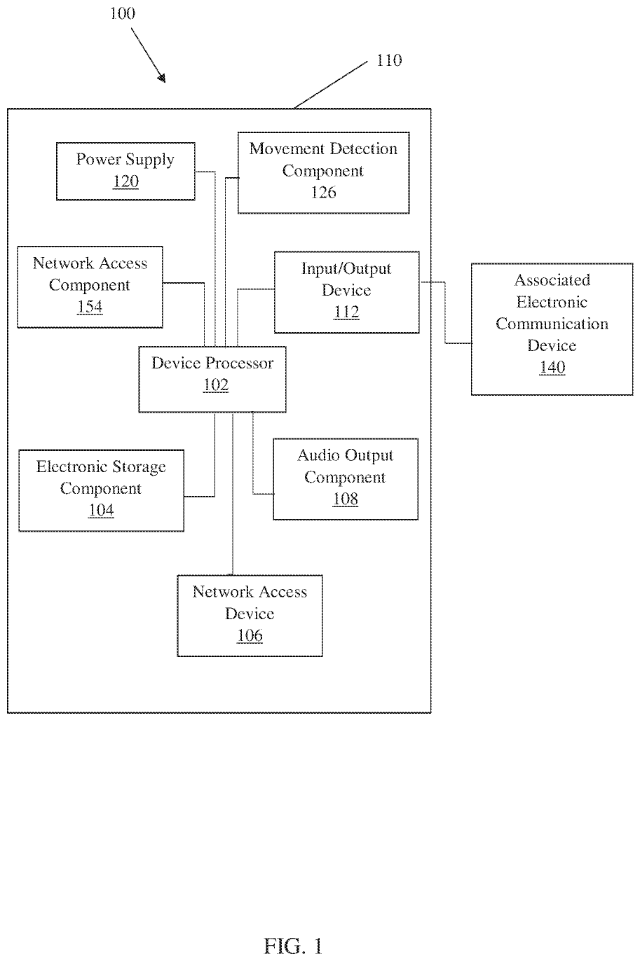

FIG. 1 is a block diagram of one embodiment of an interactive electronic device 100 as shown as described herein. As shown in FIG. 1, the interactive electronic device 100 may comprise a device processor 102, movement detection component 126, electronic storage component 104, and audio output component 108. The device processor 102 may be operatively connected to the movement detection component 126, electronic storage component 104, and audio output component 108.

The movement detection component 126 may be fixed in location relative to the interactive electronic device 100, such that as the interactive electronic device 100 is moved, the movement detection component 126 moves as well. In one embodiment, the movement detection component 126 is an accelerometer. The movement detection component 126 may generate a movement signal based on movement of the interactive electronic device 100. The movement signal may be sent to the device processor 102 in order to provide information regarding the interactive electronic device 100's physical location and/or movement.

The electronic storage component 104 may comprise an audio file, such as an audio book, educational lesson, song, or other file having an audio component. In one embodiment, the audio file may comprise audio file sub-parts, such that the sum of the audio file sub-parts comprise an audio book, educational lesson, song, or other full audio file. For example, the audio sub-parts may comprise 10 second audio file portions of the audio file, such that as long as the 10 second files are played sequentially, an audio output would sound like the complete audio file is being output seamlessly. The length of the audio sub-parts may be substantially any length of time that is shorter than the length of the audio file, and the length of the audio sub-parts need not be equal in length. In one embodiment, the electronic storage component may be a microSD card reader and microSD card, or other removeable media system.

The audio file may be configured to be output by the audio output component 108. In one embodiment, the audio output component 108 may comprise an audio board and speaker. In another embodiment, the audio output component 108 may comprise an audio wireless or Bluetooth connection component operatively coupled to an independent speaker.

In one embodiment, the movement signal may be transmitted to the device processor 102 for processing. The device processor 102 may receive a plurality of movement signals from the movement detection component 126 and aggregate the information sent such that an average movement value is generated.

The device processor 102 may be configured to cause the audio file to be output by the audio output component 108 depending on the movement signals generated by the movement detection component 126.

In one embodiment, the device processor 102 may be configured to cause the audio file to be output by the audio output component 108 if and when the average movement value reaches a predetermined value. Further, the device processor 102 may be configured to cause sequential audio file sub-parts to be output by the audio output component 108 if and when the average movement value reaches or exceeds the predetermined value and cease playback of subsequent audio file sub-parts if the average movement value falls below the predetermined value. Playback may resume once the average movement value reaches or exceeds the predetermined value. The predetermined value may be set such that when the predetermined value is reached, it would indicate that the interactive electronic device 100 has achieved a certain amount of movement or continuous motion. In one embodiment, the movement signal may measure the absolute value of movement. In an alternate embodiment, the movement signal may measure the overall value of movement.

In another embodiment, the device processor 102 may be configured to cause the audio file to be output by the audio output component 108 for as long as the movement signals indicate that the interactive electronic device 100 is in motion, without regard to an average movement value.

In one embodiment, sequential audio file sub-parts may be output by the audio output component 108 until the movement detection component 126 indicates that the interactive electronic device is no longer moving, or alternatively, has been at rest for a set amount of time.

In an embodiment, the interactive electronic device 100 may also comprise an input/output device 112 coupled to one or more of the device processor 102, the movement detection component 126, the network access device 106, and/or any other electronic component of the interactive electronic device 100. Input may be received based on data generated by the movement detection component 126, and output may be provided to a user or another device via the input/output device 112.

The input/output device 112 may comprise an interface port (not shown) such as a wired interface, for example a serial port, a Universal Serial Bus (USB) port, an Ethernet port, or other suitable wired connection. The input/output device 112 may comprise a wireless interface (not shown), for example a transceiver using any suitable wireless protocol, for example Wi-Fi (IEEE 802.11), Bluetooth®, infrared, or other wireless standard. For example, the input/output device 112 may communicate with a smartphone, or other associated electronic communication device 140, via Bluetooth® such that the inputs and outputs of the smartphone may be used by the user to interface with the interactive electronic device 100. In an embodiment, the input/output device 112 may comprise a user interface. The user interface may comprise at least one of lighted signal lights, gauges, boxes, forms, check marks, avatars, visual images, graphic designs, lists, active calibrations or calculations, 2D interactive fractal designs, 3D fractal designs, 2D and/or 3D representations of vapor devices and other interface system functions.

In one embodiment, user information may be collected and stored. User information may comprise data gathered by the movement detection component 126 and/or information relating to the audio file. The information relating to the audio file may include how much of the audio file has been output, the audio file sub-part being output, the status of the audio file's output, or any other information relating to the interactive electronic device. The user information may be transmitted by the input/output device to the associated electronic communication device 140. The user information may then be utilized by the user and/or associated electronic communication device 140. In one embodiment, the user information transmitted to the associated electronic communication device 140 may be utilized to continue a user's experience, such as by presenting additional information or stimulus to the user through the associated electronic communication device 140 and/or the interactive electronic device based on the user information. For example, additional content may be unlocked or made accessible on the associated electronic communication device 140 based on the user information.

The interactive electronic device 100 may comprise any suitable housing 110 for enclosing and protecting the various components disclosed herein. The interactive electronic device 100 may comprise a device processor 102 operable to control the operation of the interactive electronic device 100. The processor 102 may be, or may comprise, any suitable microprocessor 102 or microcontroller, for example, a low-power application-specific controller (ASIC) and/or a field programmable gate array (FPGA) designed or programmed specifically for the task of controlling a device as described herein, or a general purpose central processing unit (CPU), for example, one based on 80 x 86 architecture as designed by Intel™ or AMD™, or a system-on-a-chip as designed by ARM™. The processor 102 may be coupled (e.g., communicatively, operatively, etc.) to auxiliary devices or modules of the interactive electronic device 100 using a bus or other coupling. The interactive electronic device 100 may comprise a power supply 120. The power supply 120 may comprise one or more batteries and/or other power storage devices (e.g., capacitor) and/or a port for connecting to an external power supply. The one or more batteries may be rechargeable. The one or more batteries may comprise a lithium-ion battery (including thin film lithium ion batteries), a lithium-ion polymer battery, a nickel-cadmium battery, a nickel metal hydride battery, a lead-acid battery, combinations thereof, and the like. For example, an external power supply may supply power to the interactive electronic device 100 and a battery may store at least a portion of the supplied power.

The interactive electronic device 100 may comprise a memory device 104 coupled to the processor 102. The memory device 104 may comprise a random access memory (RAM) configured for storing program instructions and data for execution or processing by the processor 102 during control of the interactive electronic device 100. When the interactive electronic device 100 is powered off or in an inactive state, program instructions and data may be stored in a long-term memory, for example, a non-volatile magnetic optical, or electronic memory storage device (not shown). At least one of the RAM or the long-term memory may comprise a non-transitory computer-readable medium storing program instructions that, when executed by the processor 102, cause the interactive electronic device 100 to perform all or part of one or more methods and/or operations described herein. Program instructions may be written in any suitable high-level language, for example, C, C++, C# or the Java™, and compiled to produce machine-language code for execution by the processor 102.

In one embodiment, the interactive electronic device 100 may comprise a network access device 106 allowing the interactive electronic device 100 to be coupled to one or more ancillary devices (not shown) such as via an access point (not shown) of a wireless telephone network, local area network, or other coupling to a wide area network, for example, the Internet. In that regard, the processor 102 may be configured to share data with the one or more ancillary devices via the network access device 106. The shared data may comprise, for example, usage data and/or operational data of the interactive electronic device 100, a status of the interactive electronic device 100, a status and/or operating condition of one or more the components of the interactive electronic device 100, and/or any other data. Similarly, the processor 102 may be configured to receive control instructions from the one or more ancillary devices via the network access device 106. For example, a configuration of the interactive electronic device 100, an operation of the interactive electronic device 100, and/or other settings of the interactive electronic device 100, may be controlled by the one or more ancillary devices via the network access device 106. For example, an ancillary device may comprise a server that may provide various services and another ancillary device may comprise a smartphone for controlling operation of the interactive electronic device 100. In some embodiments, the smartphone or another ancillary device may be used as a primary input/output of the interactive electronic device100 such that data may be received by the interactive electronic device 100 from the server, transmitted to the smartphone, and output on a display of the smartphone. In an embodiment, data transmitted to the ancillary device may comprise the user information. For example, the interactive electronic device 100 may be configured to transmit the user information to the ancillary device in order to pick up on the ancillary device where the user left off on the interactive electronic device 100.

In an alternative embodiment, the interactive electronic device 100 and output of audio files as described may be coupled or linked to a second interactive electronic device (not pictured). The second interactive electronic device may be substantially similar to the interactive electronic device 100. In this embodiment, each of the interactive electronic device 100 and second electronic interactive device may be configured to communicate with one another and provide for output of multiple respective audio files to output a narrative, such that playback of this narrative requires continuous movement of both interactive electronic devices. In an additional alternate embodiment, more than two interactive electronic devices may be used to communicate with one another and output a narrative. For example, in a use scenario where the audio file is a narrative story comprising multiple characters, multiple interactive electronic devices may be assigned or be related to individual characters, such that progressing through the narrative by, for example, outputting a particular character's lines requires continuous movement of the respective interactive electronic devices. In an additional alternative embodiment, either of the interactive electronic devices may be configured to require participation or interactive of the user in order to progress a narrative. For example, after a portion of audio is output on the interactive electronic device 100, the user may engage with the second interactive device to reinforce concepts or ideas based on the audio output, such as by taking a quiz related thereto.

In one embodiment, the interactive electronic device 100 may be a stand-alone wearable device, or a mobile device. In one embodiment of the invention, the interactive electronic device 100 may comprise a geo-spatial awareness component which may be couple to a camera. In this embodiment, the interactive electronic device may be configured to output audio based on location, orientation, and/or what is seen by the camera.

One potential scenario where the interactive electronic device 100 may be beneficial is for providing the interactive electronic device 100 to stroke patients or other individuals requiring improved motor coordination. Generation of audio output by the interactive electronic device 100 may be configured to require assessment of cognitive and motor functions, voice recognition, and spatial awareness.

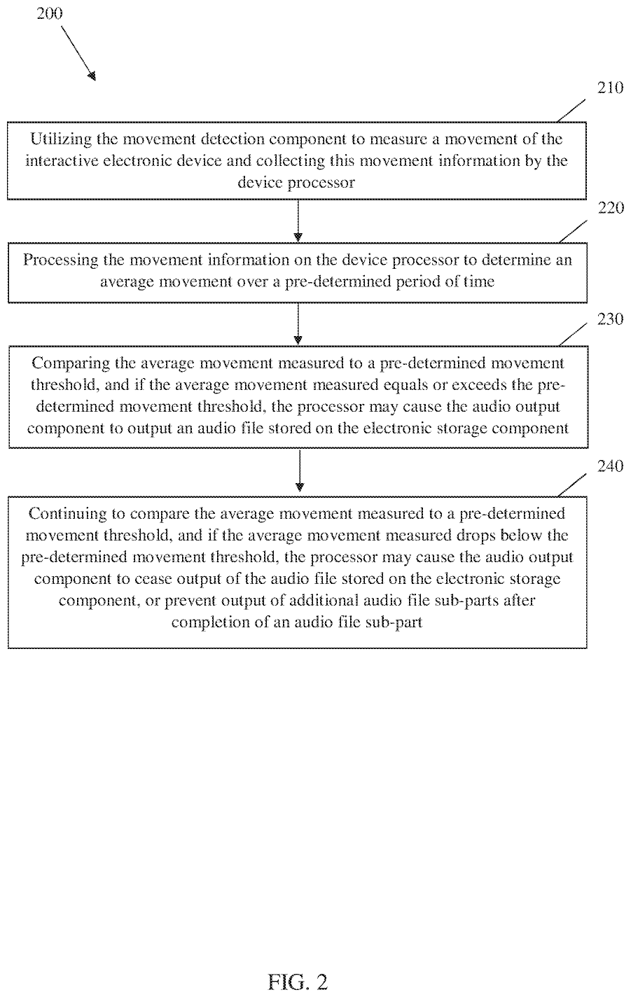

In an embodiment, illustrated in FIG. 2, a method 200 may be provided for outputting audio or other stimulus to a user based on movement, wherein as the user moves as measured by a movement detection component 126 of an interactive electronic device 100.

The method may comprise the step 210 of utilizing the movement detection component 126 to measure a movement of the interactive electronic device 100 and collecting this movement information by the device processor 102.

The method may further comprise the step 220 of processing the movement information on the device processor 102 to determine an average movement over a pre-determined period of time. In one embodiment, the pre-determined period of time may be 10 seconds, or substantially any other practicable measurement of time.

The method may also comprise the step 230 comparing the average movement measured to a pre-determined movement threshold, and if the average movement measured equals or exceeds the pre-determined movement threshold, the processor 102 may cause the audio output component 108 to output an audio file stored on the electronic storage component 104.

The method may further comprise the step 240 of continuing to compare the average movement measured to a pre-determined movement threshold, and if the average movement measured drops below the pre-determined movement threshold, the processor 102 may cause the audio output component 108 to cease output of the audio file stored on the electronic storage component 104, or prevent output of additional audio file sub-parts after completion of an audio file sub-part.

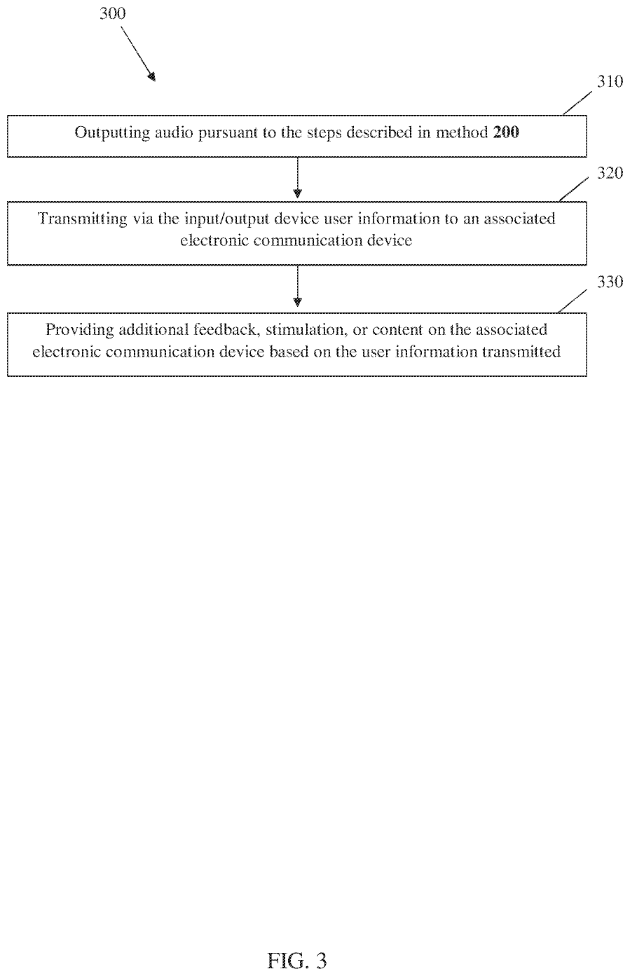

In an embodiment, illustrated in FIG. 3, a method 300 may be provided for transmitting user information from the interactive electronic device 100 to an associated electronic communication device to allow the associated electronic communication device to provide a stimulus based on the user information.

The method may comprise the step 310 of outputting audio pursuant to the steps described in method 200.

The method may further comprise the step 320 of transmitting via the input/output device 112 user information to an associated electronic communication device.

The method may also comprise the step 330 of providing additional feedback, stimulation, or content on the associated electronic communication device based on the user information transmitted.

In view of the exemplary systems described herein, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An interactive electronic device comprising:
a device processor operable for controlling the interactive electronic device;
a movement detection component operatively coupled to the device processor and controlled in part by the device processor, wherein the movement detection component generates a movement signal based on a movement of the interactive electronic device;
an electronic storage component operatively coupled to the device processor and controlled in part by the device processor, wherein the electronic storage component stores at least one electronic file; and
an audio output component operatively coupled to the device processor and controlled in part by the device processor, wherein the audio output component is configured to output the electronic file as instructed by the device processor;
wherein the electronic file comprises an audio recording of a narrative; and
wherein the device processor is configured to cause the electronic file to be output by, at least, the audio output component based on the generated movement signal.

2. The interactive electronic device of claim 1, wherein the movement signal comprises an average acceleration of the movement detection component.

3. The interactive electronic device of claim 2, wherein the device processor is configured to cause the electronic file to be output by, at least, the audio output component when the average acceleration of the movement detection component exceeds a pre-determined value.

4. The interactive electronic device of claim 3, wherein the device processor is configured to stop playback of the electronic file by the audio output component when the average acceleration is below a pre-determined value.

5. The interactive electronic device of claim 1, wherein the device processor is configured to start playback of the electronic file when the movement detection component indicates the interactive electronic device is moving.

6. The interactive electronic device of claim 5, wherein the device processor is configured to stop playback of the electronic file by the audio output component when the generated movement signal indicates that the movement detection component has stopped moving.

7. The interactive electronic device of claim 1, wherein the movement detection component continuously transmits the generated movement signal to the device processor.

8. The interactive electronic device of claim 7, wherein the device processor is configured to continue playback of the electronic file by the audio output component as long as the generated movement signal indicates that the movement detection component is in movement.

9. The interactive electronic device of claim 8, further comprising:
an input/output device operatively coupled to the device processor and configured to operatively connect the device processor to an associated electronic communication device, wherein the input/output device is configured to send a plurality of electronic communications to the associated electronic communication device, wherein the plurality of sent electronic communications comprise data comprising movement data and electronic file output status.

10. The interactive electronic device of claim 9, wherein the associated electronic communication device displays to a user the data comprising movement data and the file output status.

11. The interactive electronic device of claim 10, wherein the file output status comprises how much of the electronic file has been output.

12. The interactive electronic device of claim 10, wherein the movement data comprises movement of the interactive electronic device.

13. The interactive electronic device of claim 10, wherein the associated electronic communication device provides interaction with the user depending on the file output status and the movement data.

14. (canceled)

15. The interactive electronic device of claim 1, wherein the audio output is a speaker.

16. The interactive electronic device of claim 1, wherein the audio output is an audio jack.

17. The interactive electronic device of claim 1, wherein the audio output is a wireless audio transmission component.

18. The interactive electronic device of claim 1, wherein the electronic storage component is a removeable storage mechanism.

19. An interactive electronic device comprising:
a device processor operable for controlling the interactive electronic device;
a movement detection component operatively coupled to the device processor and controlled in part by the device processor, wherein the movement detection component generates a movement signal based on a movement of the interactive electronic device;
an electronic storage component operatively coupled to the device processor and controlled in part by the device processor, wherein the electronic storage component stores at least one electronic file;
an audio output component operatively coupled to the device processor and controlled in part by the device processor, wherein the audio output component is configured to output the electronic file as instructed by the device processor; and
an input/output device operatively coupled to the device processor and configured to operatively connect the device processor to an associated electronic communication device, wherein the input/output device is configured to send a plurality of electronic communications to the associated electronic communication device, wherein the plurality of sent electronic communications comprise data comprising movement data and electronic file output status;
wherein the device processor is configured to cause the electronic file to be output by, at least, the audio output component based on the generated movement signal;
wherein the movement signal comprises an average acceleration of the movement detection component;
wherein the device processor is configured to cause the electronic file to be output by, at least, the audio output component when the average acceleration of the movement detection component exceeds a pre-determined value;
wherein the device processor is configured to stop playback of the electronic file by the audio output component when the average acceleration is below a pre-determined value;
wherein the movement detection component continuously transmits the generated movement signal to the device processor;
wherein the device processor is configured to continue playback of the electronic file by the audio output component as long as the generated movement signal indicates that the movement detection component is in movement;
wherein the file output status comprises how much of the audio file has been output;
wherein the movement data comprises movement of the interactive electronic device;
wherein the associated electronic communication device provides interaction with the user depending on the file output status and the movement data;
wherein the electronic file comprises an audio recording of a narrative;
wherein the audio output is a speaker; and wherein the electronic storage component is a removeable storage mechanism.
